(19) United States
(12) Patent Application Publication
(10) Pub. No.: US 2023/0401266 A1
(43) Pub. Date: Dec. 14, 2023

(54) ALLOWING USERS TO CONTROL RECOMMENDATIONS FROM A RECOMMENDATION SYSTEM BASED ON EXPLANATION VECTORS

(71) Applicant: META PLATFORMS, INC., Menlo Park, CA (US)

(72) Inventor: Rajesh Krishna Shenoy, Cupertino, CA (US)

(21) Appl. No.: 17/837,866

(22) Filed: Jun. 10, 2022

(51) Int. Cl. G06F 16/9535; G06Q 50/00

(52) U.S. Cl. CPC G06F 16/9535; G06Q 50/01

(57) ABSTRACT

A computing device may receive a search query and access a plurality of content objects associated with a system based on the search query. The computing device may determine a plurality of explanation vectors (e.g., comprising characteristics of a user) based on the plurality of content objects. The plurality of explanation vectors may correspond to at least one content object of the plurality of content objects. The computing device may determine a similarity score between a first object of the plurality of content objects and a second object of the plurality of content objects. The similarity score may be determined based at least in part on a first explanation vector corresponding to the first object and a second explanation vector corresponding to the second object. A response including the second object to the search query may be transmitted by the computing device based on the similarity score.

### TECHNICAL FIELD

Exemplary embodiments of this disclosure relate generally to methods, apparatuses, and computer program products for providing content to users associated with a system.

### BACKGROUND

A social-networking system, which may include a social-networking website, may enable its users (such as persons or organizations) to interact with the social-networking system and with each. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with content and/or other users of the social-networking system, as well as provide services (e.g., wall posts, photo-sharing, event organization, messaging, games, or advertisements) to facilitate social interaction between or among users.

The social-networking system may send (e.g., over one or more networks) content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

The social-networking system may utilize one or more recommendation systems to show users content objects in which they may be interested. Large scale recommendation systems may process many signals via complex machine learning algorithms (e.g., trained over many users and many events) to show a content object to a user. However, a user may dislike a content object recommended or may want to control the content objects recommended by a recommendation system. The ability for users to control such recommendations is currently limited.

For example, many recommendation systems may allow a user to choose “more items” or “less items” regarding a specific content object they are shown. The developers of such recommendation systems may guess regarding the user's intention to control the recommendation system based on the user's input. In some cases, the recommendation system may choose to select an attribute of the content object (e.g., a product type or a topic of the item) and increase or decrease display of other content objects of the same attribute. However, the selected attribute may not be what the user intends when they choose “more” or “less.” Thus, there is a need for improved social-networking systems and recommendation systems.

### BRIEF SUMMARY

In particular exemplary embodiments, a search query may be received (e.g., by a computing device from a user). A plurality of content objects associated with a social-networking system may be accessed based on the search query. A plurality of explanation vectors may be determined based on the plurality of content objects. Each explanation vector of the plurality of explanation vectors may correspond to at least one content object of the plurality of content objects. For example, the search query may be associated with a user(s) and each explanation vector of the plurality of explanation vectors may comprise one or more characteristics of the user(s), one or more past events associated with the user(s) and/or one or more contacts (e.g., a friend(s)) of the user(s), at least one user event type (e.g., conversion, click, view, like, comment, post, etc.), and/or at least one user event identifier (e.g., category, company, website, etc.).

In particular exemplary embodiments, a similarity score between a first object of the plurality of content objects and a second object of the plurality of content objects may be determined. The similarity score may be computed based at least in part on a first explanation vector corresponding to the first object and a second explanation vector corresponding to the second object. Moreover, the similarity score may be based at least in part on a comparison of the first explanation vector and the second explanation vector.

In particular exemplary embodiments, a response comprising the second object to the search query may be transmitted based on the similarity score. Moreover, an explanation associated with the response may be provided (e.g., to the user(s)).

In particular exemplary embodiments, an indication of one or more user-interactions associated with the first content object of the plurality of content objects may be received. At least a first explanation vector of the plurality of explanation vectors may be modified based on the one or more user-interactions.

In one example embodiment, a method is provided. The method may include receiving, by a computing device, a search query and accessing, by the computing device based on the search query, a plurality of content objects associated with a system. The method may further include determining, by the computing device based on the plurality of content objects, a plurality of explanation vectors. The plurality of explanation vectors may correspond to at least one content object of the plurality of content objects. The method may further include determining, by the computing device, a similarity score between a first object associated with the plurality of content objects and a second object associated with the plurality of content objects. The similarity score may be determined based at least in part on a first explanation vector corresponding to the first object and a second explanation vector corresponding to the second object. The method may further include transmitting, by the computing device based on the similarity score, a response comprising the second object to the search query.

In another example embodiment, a computer program product is provided. The computer program product includes at least one computer-readable storage medium having computer-executable program code instructions stored therein. The computer-executable program code instructions may include program code instructions configured to receive a search query and access, based on the search query, a plurality of content objects associated with a system. The computer program product may further include program code instructions configured to determine, based on the plurality of content objects, a plurality of explanation vectors. The plurality of explanation vectors may correspond to at least one content object of the plurality of content objects. The computer program product may further include program code instructions configured to determine a similarity score between a first object associated with the plurality of content objects and a second object of the plurality of content objects. The similarity score may be determined based at least in part on a first explanation vector corresponding to the first object and a second explanation vector corresponding to the second object. The computer program product may further include program code instructions configured to transmit, based on the similarity score, a response comprising the second object to the search query.

In yet another example embodiment, a device is provided. The device may include one or more processors and a memory including computer program code instructions. The memory and computer program code instructions are configured to, with at least one of the processors, cause the device to at least perform operations including receiving a search query and accessing, based on the search query, a plurality of content objects associated with a system. The memory and computer program code are also configured to, with the processor, cause the device to determine, based on the plurality of content objects, a plurality of explanation vectors. The plurality of explanation vectors may correspond to at least one content object of the plurality of content objects. The memory and computer program code are also configured to, with the processor, cause the device to determine a similarity score between a first object associated with the plurality of content objects and a second object associated with the plurality of content objects. The similarity score may be determined based at least in part on a first explanation vector corresponding to the first object and a second explanation vector corresponding to the second object. The memory and computer program code are also configured to, with the processor, cause the device to transmit, based on the similarity score, a response comprising the second object to the search query.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an example network environment associated with a social-networking system in accordance with an exemplary embodiment.

FIG. 2 illustrates an example client system associated with a social-networking system in accordance with an exemplary embodiment.

FIG. 3 illustrates an example explanation vector associated with a social-networking system in accordance with an exemplary embodiment.

FIG. 4 illustrates an example method for providing search results to a user based on a plurality of explanation vectors in accordance with an exemplary embodiment.

FIG. 5 illustrates an example computer system in accordance with an exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

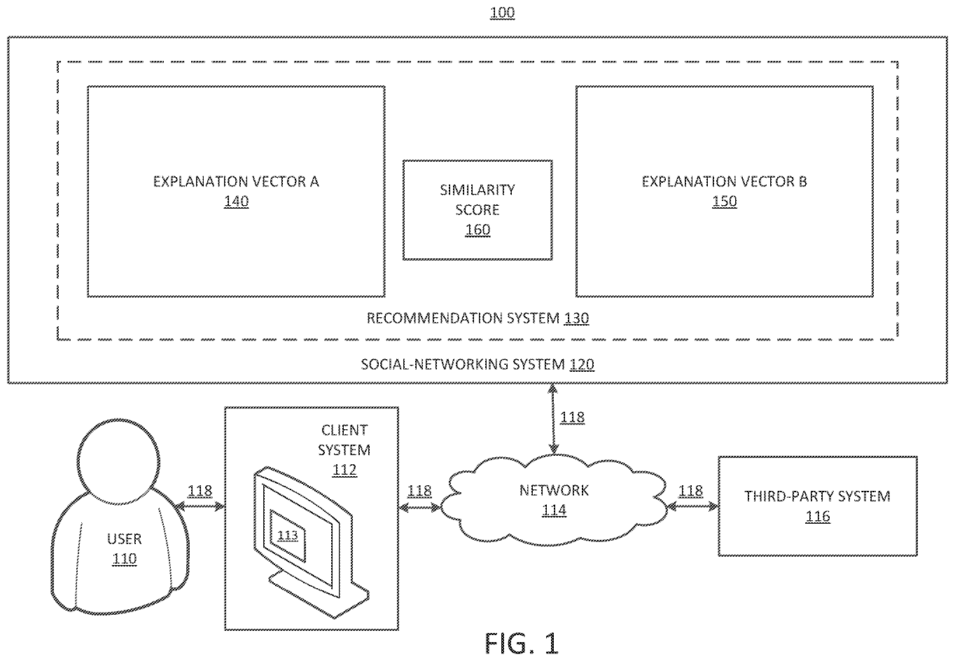

FIG. 1 illustrates an example network environment 100 associated with a social-networking system. Network environment 100 includes a user 110, a client system 112, a social-networking system 120, and a third-party system 116 connected to each other by a network 114. Although FIG. 1 illustrates a particular arrangement of user 110, client system 112, social-networking system 120, third-party system 116, and network 114, this disclosure contemplates any suitable arrangement of user 110, client system 112, social-networking system 120, third-party system 116, and network 114. As an example, and not by way of limitation, two or more of client systems 112, social-networking systems 120, and third-party systems 116 may be connected to each other directly, bypassing network 114. As another example, two or more of client systems 112, social-networking systems 120, and third-party systems 116 may be physically or logically co-located with each other in whole or in part. Moreover, although FIG. 1 illustrates a particular number of users 101, client systems 112, social-networking systems 120, third-party systems 116, and networks 114, this disclosure contemplates any suitable number of users 101, client systems 112, social-networking systems 120, third-party systems 116, and networks 114. As an example, and not by way of limitation, network environment 100 may include multiple users 101, client systems 112, social-networking systems 120, third-party systems 116, and networks 114.

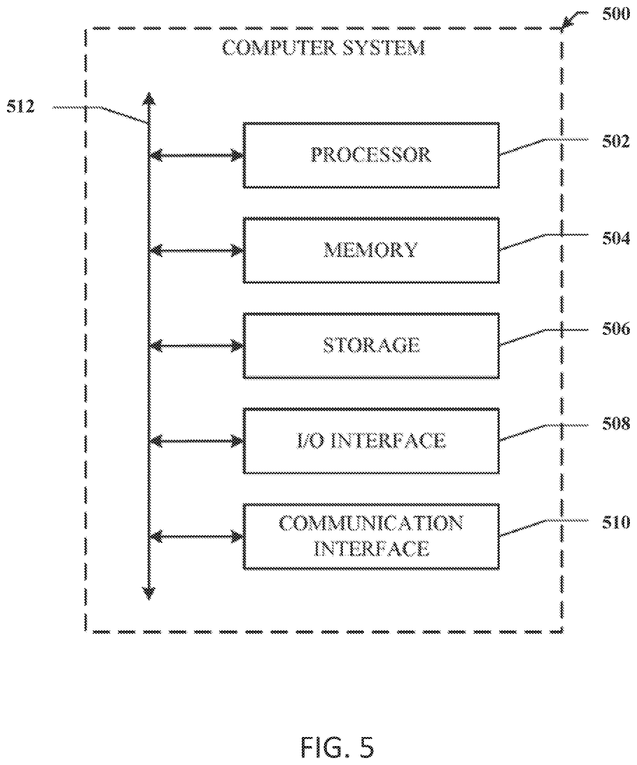

In particular exemplary embodiments, user 110 may be an individual (e.g., human user), an entity (e.g., an enterprise, business, or third-party application), or a group (e.g., of individuals or entities) that interacts or communicates with or over social-networking system 120. In particular exemplary embodiments, social-networking system 120 may be a network-addressable computing system (e.g., computer system 500 of FIG. 5 (e.g., also referred to herein as network device 500)) hosting an online social network. Social-networking system 120 may generate, store, receive, and/or send social-networking data, such as, for example, user-profile data, user event data, user selection data, and/or other suitable data related to the online social network. Social-networking system 120 may be accessed by the other components of network environment 100 either directly or via network 114. In particular exemplary embodiments, social-networking system 120 may include an authorization server (or other suitable component(s)) that allows users 101 to opt in to or opt out of having their actions logged by social-networking system 120 or shared with other systems (e.g., third-party systems 116), for example, by setting appropriate privacy settings. A privacy setting of a user may determine what information associated with the user may be logged, how information associated with the user may be logged, when information associated with the user may be logged, who may log information associated with the user, whom (e.g., which users) information associated with the user may be shared with, and for what purposes information associated with the user may be logged or shared.

Authorization servers may be used to enforce one or more privacy settings of the users of social-networking system 120 through blocking, data hashing, anonymization, or other suitable techniques as appropriate. In particular exemplary embodiments, third-party system 116 may be a network-addressable computing system. Third-party system 116 may generate, store, receive, and send content items, such as, for example, text, images, video, or any other content items. Third-party system 116 may be accessed by the other components of network environment 100 either directly or via network 114. In particular exemplary embodiments, one or more users 101 may use one or more client systems 112 to access, send data to, and receive data from social-networking system 120 or third-party system 116. Client system 112 may access social-networking system 120 or third-party system 116 directly, via network 114, or via a third-party system. As an example, and not by way of limitation, client system 112 may access third-party system 116 via social-networking system 120. Client system 112 may be any suitable computing device, such as, for example, a personal computer, a laptop computer, a cellular telephone, a smartphone, a tablet computer, or an augmented/virtual reality device.

This disclosure contemplates any suitable network 114. As an example and not by way of limitation, one or more portions of network 114 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 114 may include one or more networks 114.

Links 118 may connect client system 112, social-networking system 120, and third-party system 116 to communication network 114 or to each other. This disclosure contemplates any suitable links 118. In particular embodiments, one or more links 118 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 118 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 118, or a combination of two or more such links 118. Links 118 need not necessarily be the same throughout network environment 100. One or more first links 118 may differ in one or more respects from one or more second links 118.

In particular exemplary embodiments, social-networking system 120 may include a recommendation system 130. For example, recommendation system 130 may be used to show user 110 items (e.g., news, advertisements, etc.) which may be of interest to user 110. Recommendation system 130 may use several signals obtained from the user 110 to show the items. In particular exemplary embodiments, large scale systems may use a multitude of signals which may be processed via complex machine learning algorithms trained over many users and many events to show an item to a user (e.g., user 110). User 110 may dislike a recommended item, or may want to control the items recommended by the recommendation system 130.

In conventional systems, the ability to perform such customization is currently limited. For example, conventional recommendation systems may allow a user to choose “more items” or “less items” in relation to a specific item the user is shown. Developers of conventional recommendation systems may guess regarding a user's intention to control the recommendation system based on the user's input. In some cases, a conventional recommendation system may choose to focus one attribute of the specific item (e.g., a product type or topic of the item) and increase or decrease other items of the same attribute. However, the attribute chosen by the recommendation system may not accurately reflect what the user wanted to see “more” or “less” of in relation to the specific item.

Unlike conventional recommendation systems, recommendation system 130 may be specialized to a user (e.g., user 110) based on more than just a single characteristic of a specific item. For example, recommendation system 130 may provide “more” or “less” control for user 110 based on the current item shown as well as characteristics of the user 110. Moreover, if two separate users select to “see more” or “see less” of a particular item, a list of items shown to each user may be different and may be personalized to each user. Conventional recommendation systems are typically incapable of achieving such combined user-item refinement.

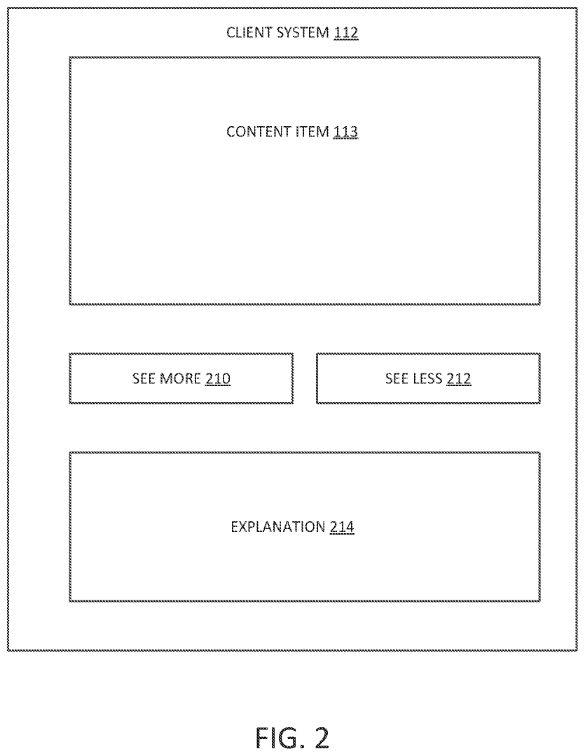

In particular exemplary embodiments, recommendation system 130 may use explanation vectors (e.g., explanation vector A 140 and explanation vector B 150) to capture reasoning associated with display of a content item 113 (see e.g., FIG. 2) to user 110 of why a content item (e.g., content item 113) was shown to the user. The value of the explanation vectors (e.g., explanation vector A 140 and explanation vector B 150) may denote the importance of an event in showing the content item 113 to the user 110. For example, in an instance in which the user 110 clicks on a specific post and that specific post caused the content item 113 to be shown, a weight of a feature relating to the specific post may be high and weights of other features may be low.

An explanation vector (e.g., explanation vector A 140 and explanation vector B 150) may include a set of a user's (e.g., user 110) past events which caused the content item 113 to be shown. For example, the explanation vector (e.g., explanation vector A 140 and explanation vector B 150) may include information comprising a click on a post(s), a comment on a video(s), a visit to a web site(s), etc. (e.g., any signal(s) which may be used to recommend the item). Moreover, the information included in the explanation vector (e.g., explanation vector A 140 and explanation vector B 150) may be associated with one or more past events of a contact(s) (e.g., a friend(s)) of the user (e.g., user 110). The information included in the explanation vector (e.g., explanation vector A 140 and explanation vector B 150) may be formatted according to any appropriate semantic. Moreover, the information may be input to a machine learning model.

An algorithm(s) may be used by the recommendation system 130 to generate explanation vectors (e.g., explanation vector A 140 and explanation vector B 150). For example, an algorithm(s) may include one or more of local interpretable model-agnostic explanations (LIME) or integrated gradients. According to some exemplary embodiments, the output of such explanation generation algorithms may be used by the recommendation system 130 to provide user 110 with control of the items (e.g., content item 113) the user 110 may view (e.g., via client system 112).

According to some exemplary embodiments, each explanation vector (e.g., explanation vector A 140 and explanation vector B 150) may comprise user inputs that may cause content item 113 to rank higher in the list of recommendations. The explanation vector may be based on one or more of the characteristics of the user 110, the characteristics of the item 113 as well as interactions between related items. An explanation may include a condensed representation of a prediction of the machine learning algorithm for inputs of the user 110 as well as characteristics of the item 113.

According to some exemplary embodiments, the explanation vector (e.g., explanation vector A 140 and explanation vector B 150) may be used to compare different items that may be shown to the user 110. This comparison may be personalized to both the user 110 and the item 113. Moreover, the comparison may include determining a similarity score 160. For example, the similarity score may be used to define a similarity between explanation vector A 140 and explanation vector B 160.

An example client system 112 associated with a social-networking system (e.g., social-networking system 120) is illustrated in FIG. 2. The client system 112 may present a user (e.g., user 110) with a content item 113, an interface to select to “see more” 210, an interface to select “see less” 212, and/or an explanation 214.

In particular exemplary embodiments, user 110 may select to “see more” 210 to see similar content to the content item 113. The user 110 may select to “see less” 212 to tailor content away from the content item 113.

For example, a user (e.g., user 110) may request to see more content like some aspect of the content item 113 by selecting to “see more” 210 of content item 113. The recommendation system 130 may determine a similarity score (e.g., similarity score 160) by multiplying an explanation vector of a selected item (e.g., explanation vector A 140 or explanation vector B 150) with an explanation vector of all items (e.g., explanation vector A 140 or explanation vector B 150). According to some example embodiments, a higher similarity score 160 may indicate an item (e.g., content item 113) may be shown to the user 110 for one or more of the same reasoning as ascertained by the machine learning model in regards to a selected item. According to some example embodiments, the similarity score 160 may be used to boost the items and then re-rank the items. This may result in the user 110 seeing “more items” like the item selected by the user 110.

As another example, a user (e.g., user 110) may request to see less content like some aspect of the content item 113 by selecting to “see less” 212 of content item 113. The recommendation system 130 may determine a similarity score 160 by multiplying an explanation vector of a selected item (e.g., explanation vector A 140 or explanation vector B 150) with an explanation vector of all items (e.g., explanation vector A 140 or explanation vector B 150). According to some example embodiments, a lower similarity score 160 may indicate an item may not be shown to the user 110 for one or more of the same reasoning as ascertained by the machine learning model in regards to a selected item. For example, a reciprocal of the similarity score 160 may be used to diminish the items and then re-rank the items. This may result in the user 110 seeing “less items” like the item selected by the user 110.

Moreover, the user 110 may continue to refine their preferences by using “see more” 210 or “see less” 212 in regards to content item 113. In each case, the original explanation vector (e.g., explanation vector A 140 or explanation vector B 150) may be used to find more or less items, where a solution may converge to items the user 110 may want to view.

For example, and not by way of limitation, a content item 113 may be an advertisement shown to user 110. An explanation regarding why the advertisement was shown (or was not shown) may be provided to user 110 via a display associated with client system 112. The explanation may be based on any number of input signals processed by the machine learning model. Moreover, in regards to the explanation, a subset of the input signals may be more important than the other input signals.

For example, the most important reason why the content was shown or was not shown to the user 110 may be associated with one or more actions taken by the user 110 and may be provided to the user as an explanation 214. For example, and not by way of limitation, the explanation 214 may include past purchases made by the user 110, past links that were clicked on by the user 110, etc. The explanation 214 may be based on an explanation vector (e.g., explanation vector A 140 or explanation vector B 150).

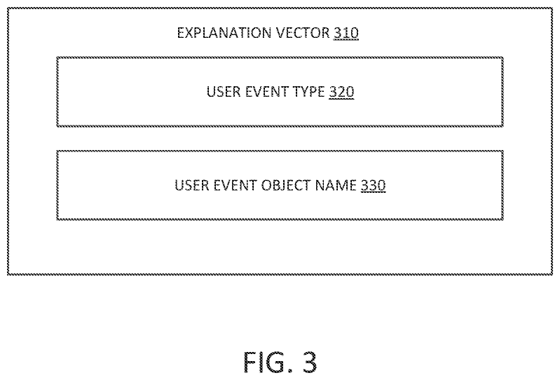

An example explanation vector 310 associated with a social-networking system (e.g., social-networking system 120) is illustrated in FIG. 3. In particular exemplary embodiments, an explanation vector may include one or more of a user event type 320 and/or a user event object name 330. User event type 320 may include one or more elements or interactions and user event object name 330 may include one or more identifiers.

In particular exemplary embodiments, social-networking system 120 may store one or more explanation vectors (e.g., explanation vector A 140, explanation vector B 150, or explanation vector 310) in one or more data stores. In particular exemplary embodiments, an explanation vector 310 may correspond to a user 110 of social-networking system 120. As an example, and not by way of limitation, a user 110 may be an individual (e.g., human user), an entity (e.g., an enterprise, business, or third-party application), or a group (e.g., of individuals or entities) that interacts or communicates with or over social-networking system 120. In particular embodiments, when a user registers for an account with social-networking system 120, social-networking system 120 may create an explanation vector 310 corresponding to the user (e.g., user 110) and store the explanation vector 310 in one or more data stores. Users and explanation vectors described herein may, where appropriate, refer to registered users (e.g., user 110) and explanation vectors (e.g., explanation vector A 140, explanation vector B 150, and/or explanation vector 310) associated with registered users (e.g., user 110). In addition, or as an alternative, users (e.g., user 110) and explanation vectors (e.g., explanation vector A 140, explanation vector B 150, and/or explanation vector 310) described herein may, where appropriate, refer to users that have not registered with social-networking system 120. In particular example embodiments, explanation vector 310 may be associated with information provided by a user (e.g., user 110) or information gathered by various systems, including social-networking system 120. As an example, and not by way of limitation, a user (e.g., user 110) may provide his or her name, profile picture, contact information, birth date, sex, marital status, family status, employment, education background, preferences, interests, or other demographic information. In particular example embodiments, explanation vector 310 may be associated with one or more data objects corresponding to information associated with a user (e.g., user 110). In particular example embodiments, explanation vector 310 may correspond to one or more webpages.

In particular example embodiments, explanation vector 310 may include a category associated with the user 110 and/or a content item 113. A category may include a content characteristic, a user characteristic, a client device characteristic, and/or any other suitable information. For example, an explanation vector 310 may include a category that designates users with the characteristic of being between the ages of 18 to 25. As another example, an explanation vector 310 may have a category that includes client devices running a type of operating system. In some embodiments, an explanation vector 310 may include a category to indicate a preference or interest of the user 110. As described more below, content may be displayed to the user 110 or via a client system 112 based on a category of the explanation vector 310.

In particular example embodiments, the explanation vector 310 may include one or more percentages associated with one or more aspects of the explanation vector 310. The one or more percentages may be used to determine the impact that a particular aspect has on the explanation vector 310. For example, an explanation vector 310 may indicate one or more aspects and a percentage associated with each of the one or more aspects.

For example, a list of elements (e.g., user event type 320) may be generated by the recommendation system 130 and provided to the client system 112 where one or more elements may be associated with an identifier (e.g., user event object name (e.g., user event object name 330)). Moreover, companies and/or entities may be associated with one or more identifiers. Interactions of the user with a company and/or entity may be incorporated into the explanation vector 310 based on the identifier associated with the company and/or entity. As another example, and not by way of limitation, a holiday may be associated with one or more identifiers.

By tailoring content presented to the user (e.g., user 110) based on user interactions (e.g., user event type) associated with one or more identifiers (e.g., user event object name 330), particular exemplary embodiments may reduce throughput (e.g., network bandwidth conservation) associated with user interactions and increase the efficiency (e.g., conservation of processing/memory resources) of the social-networking system 120. Moreover, the quality and relevance of the content item 113 presented to the user 110 is significantly increased, thus resulting in an enhanced user experience via client system 112.

In an example, a list, array, or vector (e.g., explanation vector 310) of interactions (e.g., user event type 320 and user event object name 330) of the user 110 with content items 113 may be stored by the social-networking system 120 and analyzed by the recommendation system 130. In a particular example embodiment, two content items may be similar based on their explanation vector (e.g., elements of the explanation vectors may correspond with each other). Moreover, a plurality of explanation vectors may be compared to determine a similarity between the explanation vectors. For purposes of illustration, and not of limitation, the explanation vectors may be sixty percent similar. In other examples, the explanation vectors may have a determined similarity of any other suitable percentage. The similarity may be determined by identifying the matching aspects of the explanation vectors. In an instance in which a user selects see more 210, the matching aspects of the explanation vectors may be maximized, by recommendation system 130 in response to detecting the choice of see more 210, based on similarity of an explanation vector associated with the content item (e.g., content item 113) to explanation vectors associated with past, present, and future explanation vectors associated with other content items. Likewise, a choice of see less 212 by the user 110 may maximize dissimilar aspects of the explanation vector, by recommendation system 130 in response to detecting the choice of see less 212, associated with the content item in relation to explanation vectors associated with past, present, and/or future content items.

In some example embodiments, by selecting to see more items of one type, similar items may be emphasized (e.g., “boosted”), by recommendation system 130, such as items with one or more matching object names in their respective explanation vectors. For example, and not by way of limitation, a user 110 may select to “see more” 210 of a content item 113 associated with a celebrity. Conventional “see more” techniques typically show the user more content items with the same topic (e.g., celebrity topic). However, an explanation vector 310 of the exemplary embodiments may be determined by the recommendation system 130 to boost content items that include Object Name “Skincare” in their explanation vector based on a determination that “Skincare” is common between explanation vectors associated with objects viewed by the user 110 and the content item associated with the celebrity. In such an example, “see more” 210 may boost skincare products, even though the content may not be about skin care. The user 110 may get a wider variety of results based on their past events, and/or their contacts (e.g., friends) past events, and not just more celebrity pages. Moreover, the user's selection of “see more” 210 may yield, by the recommendation system 130 in response to detecting the choice of see more 210, additional aspects of one or more explanation vectors, including skincare, media company, investing articles, etc.

A “see less” 212 use case may be determined by the recommendation system 130 in response to detecting the choice of see less 212 as a reciprocal of similarity. For example, a subsequently shown content item may be completely unrelated to the selected content item.

In particular example embodiments, a similarity (e.g., similarity score 160) between two content items may be determined by the recommendation system 130 by comparing two explanation vectors. For example, a comparison of two explanation vectors may include comparing a number of times that one or more object names (e.g., user event object name 330) match in each explanation vector 310. Moreover, the rate of the number of times that one or more object names match in each explanation vector may be compared (e.g., Object Name divided by Total Number of Object Names) by the recommendation system 130.

For example, content item A may have a user event type 320 of “conversion to a media company” and a user event object name 330 of the “media company.” Content item B may have a user event type 320 of “click on ad from a media company” and a user event object name 330 of the “media company.” A similarity (e.g., similarity score 160 of 1.0) may be determined by the recommendation system 130 based on each explanation vector 310 including a matching user event object name 330 (e.g., “media company”). As another example, if there are five explanations from each content item, and four explanations match in user event object name 330, the similarity score 160 may be determined by the recommendation system 130 based on a rate of the match (e.g., 4/5=0.8 similarity).

In particular exemplary embodiments, an explanation 214 associated with an explanation vector 310 may be composed by joining a user event type 320 with a user event object name 330. For example, an explanation vector 310 with user event type 320 of “CLICK” and a user event object name 330 of “PAGE_ID” may generate the explanation 214 of “You recently clicked on this social-network page.” In some example embodiments, an explanation vector 310 may have a user event type 320 of “WEBSITE_VISIT” and a user event object name 330 of the URL of the website.

In some example embodiments, where an explanation vector 310 has a user event type 320 or user event object name 330 that contains an advertisement identifier (e.g., SPARSE_AD_ID), a public page of the advertiser associated with the advertisement may be included in the explanation 214.

In particular example embodiments, user event type 320 may include one or more of the following event types:
CLICK=>‘You recently clicked on’;
LIKE=>‘You liked’;
IMPRESSION=>‘You recently viewed’;
USER_PAGE_EVENT=>‘You recently took an action on’;
CONVERSION=>‘You recently engaged with’;
PAGE_LINK_CLICK=>‘You recently clicked on the link of’;
ENGAGEMENT=>‘You recently engaged with’;
INTERACTION=>‘You recently interacted with’;
PHOTO_VIEW=>‘You recently viewed a photo on’; and/or
WEBSITE_VISIT=>‘You recently visited <url>’.

In particular exemplary embodiments, user event object name 330 may include one or more of the following object names:
PAGE_ID=>‘this social-network page’;
KEYWORD=>‘a page, post, or ad related to the keyword’;
ENTITY_KEY=>‘an ad from an advertiser with this public social-network page’;
VIDEO_ID=>‘this video’;
PRODUCT_ID=>‘a product from the owner of this social-network page’;
CAMPAIGN_ID=>‘an ad from an advertiser with this public social-network page’;
AD_iD=>‘an ad from an advertiser with this public social-network page’; and
STATUS_UPDATE=>‘this post’.

In some exemplary embodiments, content item 113 may include an advertisement. In other exemplary embodiments, content item 113 may be any suitable content (e.g., images, videos, audio, etc.). As an example, an advertisement may be text (which may be HTML-linked), one or more images (which may be HyperText Markup Language (HTML)-linked), one or more videos, audio, other suitable digital object files, a suitable combination of these, or any other suitable advertisement in any suitable digital format presented on one or more web pages, in one or more e-mails, or in connection with search results requested by a user. In addition, or as an alternative, an advertisement may be associated with one or more sponsored stories (e.g., a news-feed or ticker item on social-networking system 120). A sponsored story may be a social action by a user (such as for example “liking” a page, “liking” or commenting on a post on a page, RSVPing to an event associated with a page, voting on a question posted on a page, checking in to a place, using an application or playing a game, or “liking” or sharing a website) that an advertiser/entity promotes. For example, by having the social action presented within a predetermined area of a profile page of a user or other page, presented with additional information associated with the advertiser/entity, bumped up or otherwise highlighted within news feeds and/or tickers of other users, or otherwise promoted. The advertiser/entity may pay to have the social action promoted. The social action may be promoted within or on social-networking system 120. In addition, or as an alternative, the social action may be promoted outside or within social-networking system 120, where appropriate. In particular exemplary embodiments, a page may be an on-line presence (such as a webpage or website within or outside of social-networking system 120) of a business, organization, or brand facilitating its sharing of stories and/or connecting with users. A page may be customized, for example, by adding applications, posting stories, and/or hosting events.

In some exemplary embodiments, content item 113 may include a sponsored story. A sponsored story may be generated from stories in users' news feeds and promoted to specific areas within displays of users' web browsers when viewing a web page associated with social-networking system 120. Sponsored stories may be more likely to be viewed by users, at least in part because sponsored stories generally involve interactions or suggestions by the users' friends, fan pages, and/or other connections. In connection with sponsored stories, some example embodiments may utilize one or more systems, components, elements, functions, methods, operations, or steps disclosed in U.S. patent application Ser. No. 13/327,557, entitled “Sponsored Stories Unit Creation from Organic Activity Stream” and filed Dec. 15, 2011, U.S. Patent Application Publication No. 2012/0203831, entitled “Sponsored Stories Unit Creation from Organic Activity Stream” and filed Feb. 3, 2012 as U.S. patent application Ser. No. 13/020,745, or U.S. Patent Application Publication No. 2012/0233009, entitled “Endorsement Subscriptions for Sponsored Stories” and filed Mar. 9, 2011 as U.S. patent application Ser. No. 13/044,506, which are all incorporated herein by reference as an example(s) and not by way of limitation. In particular exemplary embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed Aug. 18, 2011, which is incorporated herein by reference as an example and not by way of limitation.

As described above, an advertisement may be text (which may be HTML-linked), one or more images (which may be HTML-linked), one or more videos, audio, one or more FLASH files, a suitable combination of these, or any other suitable advertisements in any suitable digital format. In particular example embodiments, an advertisement may be requested for display within third-party webpages, social-networking-system webpages, and/or other pages. An advertisement may be displayed in a dedicated portion of a page, such as in a banner area at the top of the page, in a column at the side of the page, in a graphical user interface (GUI) of the page, in a pop-up window, over the top of content of the page, or elsewhere with respect to the page. In addition, or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user 110 may interact with an advertisement in any suitable manner. The user 110 may click or otherwise select the advertisement, and the advertisement may direct the user 110 (or a browser or other application being used by the user 110) to a page associated with the advertisement. At the page associated with the advertisement, the user 110 may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 120) or RSVP (e.g., through social-networking system 120) to an event associated with the advertisement. In addition, or as an alternative, an advertisement may include social-networking-system content directed to the user 110. For example, an advertisement may display information about a friend of the user 110 within social-networking system 120 who has taken an action associated with the subject matter of the advertisement.

Social-networking-system 120 functionality or content may be associated with an advertisement in any suitable manner. For example, an advertising system (which may include hardware, software, or both for receiving bids for advertisements and selecting advertisements in response) may retrieve social-networking functionality or content from social-networking system 120 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed Oct. 5, 2010 as U.S. patent application Ser. No. 12/898,662, and in U.S. Patent Application Publication No. 2012/0232998, entitled “Selecting Social Endorsement Information for an Advertisement for Display to a Viewing User” and filed Mar. 8, 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 120.

The recommendation system 130 may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 120 to identify those users. In addition, or as an alternative, social-networking system 120 may use user-profile information in social-networking system 120 to identify those users for the advertiser. As examples and not by way of limitation, particular exemplary embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 120, or outside of social-networking system 120, or on mobile computing devices of users. When on or within social-networking system 120, such targeting may be directed to users' news feeds, search results, e-mail or other in-boxes, or notifications channels or may appear in particular area of web pages of social-networking system 120, such as a right-hand side of a web page in a concierge or grouper area (which may group along a right-hand rail advertisements associated with the same concept, node, or object) or a network-ego area (which may be based on what a user is viewing on the web page and a current news feed of the user). When outside of social-networking system 120, such targeting may be provided through a third-party website, e.g., involving an ad exchange or a social plug-in. When on a mobile computing device of a user, such targeting may be provided through push notifications to the mobile computing device.

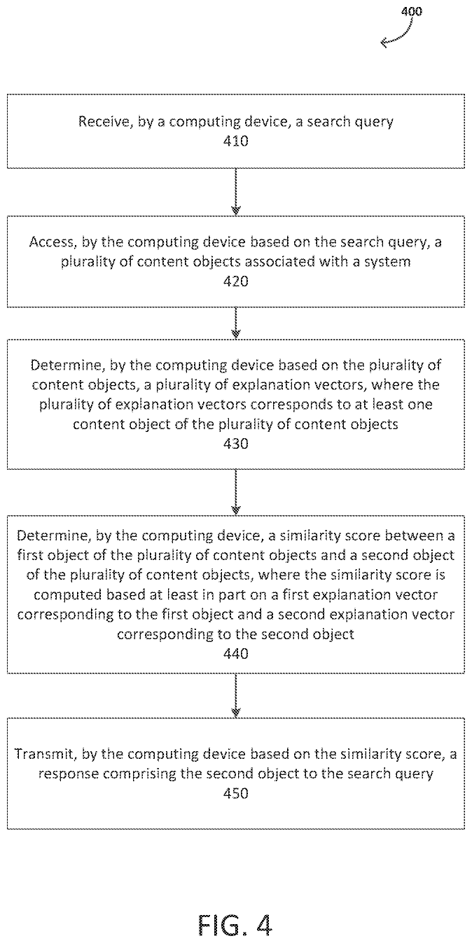

FIG. 4 illustrates an example method 400 for providing search results to a user based on a plurality of explanation vectors. In step 410, a computing device (e.g., network device 500) may receive a search query. In step 420, the computing device (e.g., network device 500) of 32 may access a plurality of content objects (e.g., content items 113) associated with a system (e.g., a social-networking system 120) based on the search query.

In step 430, the computing device (e.g., network device 500) may determine a plurality of explanation vectors (e.g., comprising characteristics of a user (e.g., user 110)) based on the plurality of content objects. The plurality of explanation vectors may correspond to at least one content object of the plurality of content objects.

In step 440, the computing device (e.g., network device 500) may determine a similarity score between a first object of the plurality of content objects and a second object of the plurality of content objects. The similarity score may be determined based at least in part on a first explanation vector corresponding to the first object and a second explanation vector corresponding to the second object. In step 440, a response comprising the second object to the search query may be transmitted by the computing device (e.g., network device 500) based on the similarity score.

Some example embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for providing search results to a user based on a plurality of explanation vectors including the particular steps of the method of FIG. 4, this disclosure contemplates any suitable method for providing search results to a user based on a plurality of explanation vectors including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

FIG. 5 illustrates an example computer system 500 (e.g., network device 500). In particular example embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM).

Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example, and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, by a computing device, a search query;
accessing, by the computing device based on the search query, a plurality of content objects associated with a system;
determining, by the computing device based on the plurality of content objects, a plurality of explanation vectors, wherein the plurality of explanation vectors corresponds to at least one content object of the plurality of content objects;
determining, by the computing device, a similarity score between a first object associated with the plurality of content objects and a second object associated with the plurality of content objects, wherein the similarity score is determined based at least in part on a first explanation vector corresponding to the first object and a second explanation vector corresponding to the second object; and
transmitting, by the computing device based on the similarity score, a response comprising the second object to the search query.

2. The method of claim 1, further comprising:
receiving an indication of one or more user-interactions associated with the first object associated with the plurality of content objects; and
modifying, based on the one or more user-interactions, at least the first explanation vector associated with the plurality of explanation vectors.

3. The method of claim 1, wherein the search query is associated with a user and the plurality of explanation vectors comprises one or more characteristics of the user.

4. The method of claim 1, wherein the search query is associated with a user and the plurality of explanation vectors comprises one or more past events associated with the user.

5. The method of claim 4, wherein the plurality of explanation vectors comprises one or more past events associated with at least one contact of the user.

6. The method of claim 1, wherein the plurality of explanation vectors comprises at least one user event type.

7. The method of claim 1, wherein the plurality of explanation vectors comprises at least one user event identifier.

8. The method of claim 1, further comprising:
transmitting, by the computing device based on the similarity score, an explanation associated with the response.

9. The method of claim 1, wherein the similarity score is based at least in part on a comparison of the first explanation vector and the second explanation vector.

10. A computer-readable medium storing instructions that, when executed, cause:
receiving a search query;
accessing, based on the search query, a plurality of content objects associated with a system;
determine, based on the plurality of content objects, a plurality of explanation vectors, wherein the plurality of explanation vectors corresponds to at least one content object of the plurality of content objects;
determine a similarity score between a first object associated with the plurality of content objects and a second object of the plurality of content objects, wherein the similarity score is determined based at least in part on a first explanation vector corresponding to the first object and a second explanation vector corresponding to the second object; and
transmit, based on the similarity score, a response comprising the second object to the search query.

11. The computer-readable medium of claim 10, wherein the instructions, when executed, further cause:
receiving an indication of one or more user-interactions associated with the first object associated with the plurality of content objects; and
modifying, based on the one or more user-interactions, at least the first explanation vector associated with the plurality of explanation vectors.

12. The computer-readable medium of claim 10, wherein the search query is associated with a user and the plurality of explanation vectors comprises one or more characteristics of the user.

13. The computer-readable medium of claim 10, wherein the search query is associated with a user and the plurality of explanation vectors comprises one or more past events associated with the user.

14. The computer-readable medium of claim 13, wherein the plurality of explanation vectors comprises one or more past events associated with at least one contact of the user.

15. The computer-readable medium of claim 10, wherein at least one explanation vector of the plurality of explanation vectors comprises at least one user event type.

16. The computer-readable medium of claim 10, wherein the plurality of explanation vectors comprises at least one user event identifier.

17. The computer-readable medium of claim 10, wherein the instructions, when executed, further cause:
transmitting, based on the similarity score, an explanation associated with the response.

18. The computer-readable medium of claim 10, wherein the similarity score is based at least in part on a comparison of the first explanation vector and the second explanation vector.

19. A device comprising:
one or more processors; and
a non-transitory memory including computer-executable instructions, which when executed by the processor, cause the device to at least:
receive a search query;
access, based on the search query, a plurality of content objects associated with a system;
determine, based on the plurality of content objects, a plurality of explanation vectors, wherein the plurality of explanation vectors corresponds to at least one content object of the plurality of content objects;
determine a similarity score between a first object associated with the plurality of content objects and a second object associated with the plurality of content objects, wherein the similarity score is determined based at least in part on a first explanation vector corresponding to the first object and a second explanation vector corresponding to the second object; and
transmit, based on the similarity score, a response comprising the second object to the search query.

20. The device of claim 19, wherein the instructions, when executed by the processors, further cause the device to:
receive an indication of one or more user-interactions associated with the first object associated with the plurality of content objects; and
modify, based on the one or more user-interactions, at least the first explanation vector associated with the plurality of explanation vectors.
